(19) United States
(12) Patent Application Publication
(10) Pub. No.: US 2003/0177274 A1
(43) Pub. Date: Sep. 18, 2003

(54) Virtual subdomain address file suffix

(76) Inventor: Chen Sun, Houston, TX (US)

Correspondence Address: Chen Sun, P.O. Box 770604, Houston, TX, 77215-0604, US

(21) Appl. No.: 10/189,063

(22) Filed: Jul. 2, 2002

Related U.S. Application Data
(60) Provisional application No. 60/363,624, filed on Mar. 12, 2002.

(51) Int. Cl. G06F 9/54

(52) U.S. Cl. 709/310

(57) ABSTRACT

Prior to this invention, a virtual subdomain address could not have a file suffix because the virtual subdomain name in a URL did not refer to a standard host that the file suffix could be applied to. With the invention, the file suffix can be added to virtual subdomains through remapping the virtual-subdomain-domain-file-suffix combination or the virtual subdomain-file suffix combination to a new address where an action script then occurs. In creating this file suffix and remapping, the user enters a file suffix name and chooses an action script to associate with this file suffix name. When a browser requests a virtual-subdomain-domain-file-suffix combination through entering it through the browser's URL box, this URL request is redirected to an address with the mapped action script. The action script then typically causes the sending of response web objects containing information previously entered or programmed for that virtual subdomain-domain-file-suffix combination. The response information typically is a database driven webpage. This invention changes the way virtual subdomain URLs can be represented and makes it indistinguishable in appearance from a standard URL. Two applications are organizing web content of a virtual subdomain address and to provide a level of privacy, security, and communications paths to virtual subdomain addresses.

### CROSS-REFERENCE TO RELATED APPLICATIONS

This application claims the benefit of Disclosure Document Deposit Request Document number 489448, filed Feb. 28, 2001 and Provisional Application 60/363,624 filed Mar. 12, 2002.

### TECHNICAL FIELD OF INVENTION

This invention relates to Internet's addressing schemes, specifically Universal Resource Locators (URL), virtual subdomains addresses, and URL file suffixes.

### FEDERAL SPONSORED RESEARCH

Not applicable

### SEQUENCE LISTING OR PROGRAM

Not applicable

### INCORPORATION BY REFERENCE

U.S. applications Ser. Nos. 09/476,632 and 09/642,127, both filed by Azkar Choudhry on Dec. 31, 1999 and Aug. 18, 2000, respectively, U.S. application Ser. No. 60/267,943 filed jointly by Chen Sun and Azkar Choudhry on May 11, 2001, and U.S. application Ser. No. 10/074,081 filed by Chen Sun on Feb. 11, 2002 are incorporated herein by reference in their entirety, including drawings and any microfiche appendices, and are hereby made a part of this application.

### BACKGROUND—DISCUSSION OF PRIOR ART

Background on Standard Domains

The Internet is not a single computer network, however, but is a hierarchy of many computer networks, all of which are interconnected by various types of server computers.

Key to success of the Internet is the addressing scheme which was adopted. The addressing scheme allows two types of addressing to be used when one computer transmits data to another computer over the Internet. The first addressing scheme, referred to as the Internet Protocol (“IP”) address, is a numeric address value consisting of four binary octets separated by a period or “dot”, such as AA.BB.CC.DD. Each of the octets is allowed to range in value from 0 to FF hexadecimal, or to 255 decimal. The values towards the left of the address, such as AA and BB, are referred to as network addresses and are used for coarse resolution of the address, while the values towards the right of the address are used for fine resolution of the address, such as CC and DD.

For example, turning to FIG. 1, the Internet backbone (1) is a set of high-speed data transmission facilities which interconnect several key switching and routing centers. Domain servers (2 and 6) may connect directly to the backbone (1), or they may connect indirectly to the backbone through other servers and other networks. For example, the domain server (2) on the right serves the subnetwork (4) on the right, which interconnects one or more client computers (5) to each other and to the Internet. Data or messages to be sent to any of the computers on the right-side network (4) must be properly addressed to be routed to them. For example, the right domain server (2) may be assigned a particular range or set of ranges of IP addresses to serve, such as 155.179.00.XX. A computer on the right-side network (4) may be given an address within this range, such as 155.179.00.213 (in decimal). A second computer on the right-side network (4) may be given an address such as 155.179.00.111. So, the octets towards the right of the IP address are subaddresses of the server's address. This scheme of addressing and subaddressing is well known within the art.

This subaddressing scheme is designed to allow subnetworking as well. For example, as shown in FIG. 1, the left-side domain server (6) may be assigned an IP address range of 98.99.YY.XX (in decimal). Computers directly connected to its subnetwork (8) would receive addresses within this range, as given in the previous example. However, another subnetwork (11), or sub-subnetwork to be literally correct, may be interconnected to the left-side network (8) via another domain server, which may be referred to as a subdomain server (9). This subdomain server may be given a range of IP addresses within the range of IP addresses for the left-side network domain server (6), such as 98.99.192.XX. The inter-networking scheme of the Internet is built upon this hierarchical structure of networks and addresses.

The use of the term “domain” with respect to addressing actually implies more than the numeric IP addressing just discussed, in Internet parlance. While computers may deal well with numeric values for addressing, human users do not deal well with long numbers. When the architects of the early versions of the Internet, known as the ARPAnet, considered previous numbering schemes for humans, such as telephone numbers, they recognized this problem. In order to make the Internet more “user-friendly”, a text-based addressing scheme was “overlaid” on top of the numeric IP addressing scheme. Thus, a hierarchy of text-based addresses was defined. At the top of the hierarchy is a domain, which in general a large range of IP addresses or group of addresses. For example, in FIG. 1, the right-side domain server (2) may be assigned an easy to remember domain name such as “uspto.gov”. Under the Internet domain name convention, the extension of the name following the period or “dot” helps to categorize the type of domain. In this example, “gov” refers to government domains. Coupled with the domain name, “uspto”, a particular domain is addressed. Other extensions, such as “com” for commercial uses, “edu” for educational institutions and “net” for network services companies, are also available.

In order for messages and data to be actually routed to a computer using a domain name, a translation to a numeric IP address must be made. This is done by a number of distributed “domain name servers” (“DNS”), which can be queried by Internet-connected machines to provide the translation. Each domain server maintains records regarding IP-to-domain name assignments for the domains which it serves. This translation technique and the protocol for updating records is described in the Internet Request For Comment (“RFC”) papers, which are public documents available from InterNIC. Of particular interest are:

RFC1033, Domain Administrators Operations Guide

RFC1034, Domain Names—Concepts and Facilities, and

RFC 1035, Domain Name—Implementation and Specification.

These are public documents, and are well known within the art.

Background on Standard Subdomains and Standard File Suffixes (/ . . . )

Continuing with the analogical structure to numeric IP addressing, domain names may be broken into two types of more resolute addresses. The first type is based upon directory structure of the file system on the server. For example, a subdirectory on the US Patent and Trademark Office's web server which contains general information might be named “gen_info”, and could be addressed as “www.uspto.gov/gen_info”. Subnetworks and virtual subnetworks may be addressed by prefixing the general domain name with a subdomain name or names. For example, a subnetwork which serves only the trademark division of the US Patent and Trademark Office may be given the subdomain name “tm”, allowing the subdomain server (such as 9 in FIG. 1) to be addressed as “tm.uspto.gov”. The two addressing schemes can be combined, such as “tm.uspto.gov/gen_info”, which would access a default file (usually index.html) located in the root directory of the subdomain server for “tm” under the domain server for “uspto.gov”.

Background on Web Clients

In this application, the term browser is used for a web client. Web clients can also include kiosks, handheld computing devices, or any IP-enabled device that can display the Internet resources available via one of the various protocols (example, http, ftp).

Background on Web Server

FIG. 2 (Prior Art) shows the well known architecture of an Apache HTTP server. The server is a combination of a computer platform with specialized software. The computer platform generally consists of a central processing unit (“CPU”) with memory (21), one or more hard disk drives (“HDD”) (22), and a network interface card (“NIC”) (23). This may be an IBM-compatible personal computer, as in the preferred embodiment, or Sun workstation or other suitable standard computer platform. A Basic Input/Output System (“BIOS”) and set of low level driver firmware modules (24) typically interfaces the higher-level software to the hardware, including a NIC driver. A multi-tasking operating system (“OS”) (25), such as Microsoft Windows NT, Linux, Unix or IBM OS/2, is also installed on the computer platform. Linux is the operating system of the preferred embodiment.

The Apache HTTP server software (27) is available for free download from the Apache Software Foundation at http://www.apache.org. It is an application program which interfaces to the Internet (1) through the NIC (23) and a Transmission Control Protocol/Internet Protocol (“TCP/IP”) communications protocol stack. The TCP/IP stack may be native to the OS, or it may be supplied as a separate but compatible module with the Apache application and the OS. Other application programs (26) such as database engines, CGI scripts, Java servlets and PHP scripts may be executed on the same platform simultaneously to the Apache HTTP server application. PHP/FI is a scripting language that supports dynamic HTML pages. It is similar to Apache's SSI, but more complex and has database modules for the most popular databases. PHP/FI is a product of Iquest Internet of Indianapolis, Ind. In the preferred embodiment, the NIC is a 100BaseT local area network interface card, interconnected to the Internet (1) backbone via one or more routers/switches.

Background on Standard Internet Addressing

FIG. 3 shows the well known arrangement of Internet browser computers, Domain Name Servers (“DNS”), Internet Service Providers (“ISP”), and domain servers. The internal architecture of domain name servers is fully described in RFC 1035. In general, when a user selects a network address, such as “http://www.anycompany.com”, in his web browser software, the browser machine (30) transmits a request (A) to the ISP (34). The ISP (34) then contacts (B) the DNS (32), which returns a translation (C) of the text-based URL to a numerical IP address value. The user's browser then requests (E) a document from the domain server (33) located at the IP address given by the DNS. The domain server (33) transmits (F) the document, typically in HTML, to the browser machine (30) via the ISP.

Definitions:

The words “domain”, “subdomain”, “virtual subdomain”, “virtual subdomain address”, “top level domain”, “file suffix”, and others have loose meanings in the industry. Some of these will be defined to help with clarification, and the defined terms will be used subsequently. The term “domain” was used loosely previously.

In an Uniform Resource Locator (URL), “http://John.AnyCompany.com/personal/photograph”, “http” is the protocol. The “John” is the subdomain name and is coupled with “AnyCompany.com”, the domain name. (AnyCompany.com is also frequently referred to as a “second-level-domain” as well as “domain”. But where the term “domain.com” is used in the figures, the word “domain” is used as a sample name.)

“com” is the top level domain name. “/personal/photograph” is the file suffix. (The file suffix is the text, punctuation, symbols, and others characters immediately to the right of the domain name. So as to facilitate verbal and data communications in the use of this invention, the invention's focus is on the commonly used URL file suffix characters, though the invention's file suffix can use a wide range of characters). “John.AnyCompany.com/personal/photograph” can be a standard subdomain-domain-file-suffix combination or a virtual-subdomain-address-file-suffix (VSAFS—defined below).

Subdomain names can have names other than “John” or “www” (as commonly seen). For examples, it can be “JohnDoe” or “MaryJones” or “Anything.” The subdomain name can reflect a standard or virtual subdomain name. (The term “real” subdomain name, as used in patent application “Contacts Management Using Virtual Subdomains” listed in Table 1 below, is the same as a “standard” subdomain name here).

A standard subdomain name is created through registering its subdomain name's text in its coupled domain's DNS routing tables. A virtual subdomain name doesn't have the subdomain name's text registered in its coupled domain's DNS routing tables, but its name's text is registered in a VSserver. A virtual subdomain address (VSA) is an address comprising of a virtual subdomain name prefixed in front of a period which is in front of a registered domain name. A virtual subdomain address is not registered in and not recognized by DNS, but is registered and recognized by a VSserver.

A virtual subdomain server (VSserver) is a server that receives virtual subdomain addresses or virtual subdomain names, has these addresses or names registered in its database, and processes these. A VSserver can return associated contacts information, webpages, launch web scripts, redirect to an IP address, and perform other computing tasks. The workings of a VSserver are described in the below listed Table 1's patent applications. A VSAServer (Virtual Subdomain Address Server) is a server similar to a VSserver and can additionally service multiple domain names.

A WebBIZcard is a virtual subdomain address (VSA) that has the person's name as the subdomain name and that when addressed by a web browser using Hypertext Transfer Protocol (http) shows the person's contacts information, typically in a graphical format. FIG. 4 (Prior Art) shows one. (Having this person's name as the subdomain name doesn't affect the way the virtual subdomain technology works, but is valuable, because a consistent naming format (having the person's name as the subdomain) should be carried across virtual subdomain address business cards. The subdomain name can also be a person's name's representation, as many people have nicknames, may prefer an alias name, and other reasons.)

Unless otherwise noted, the word “address” will refer to the text address of domains, subdomains, and file suffixes instead of their IP address, which is a set of four numbers separated by periods. Where a web browser is involved, the Hypertext Transfer Protocol (http) is the assumed protocol, unless otherwise noted.

A VSFSserver is a virtual subdomain server that further uses the file suffix to redirect. A VSAFSserver is a virtual subdomain server that uses subdomain, domain, and file suffix to produce its output. Throughout this application, note the differences between “standard” addresses and their virtual subdomain counterparts (VSA, VSAFS), which, when used in a URL may look identical, but work differently.

Terminology

| | |
|---|---|
| Domain name (also | “AnyCompany.com” in |
| known as domain) | http://John.AnyCompany.com/personal/photograph |
| File Suffix | “/personal/photograph” in |
| | http://John.AnyCompany.com/personal/photograph |
| | Text, punctuation, symbols, & others characters, |
| | including “/”, “˜”, immediately right of top level |
| | domain name in URL. |
| Subdomain name | “John” in |
| | http://John.AnyCompany.com/personal/photograph |
| top level domain | “.com” in |
| name | http://John.AnyCompany.com/personal/photograph |
| standard subdomain | Subdomain name created by registering its |
| name | subdomain name's text in its coupled domain's DNS |
| | routing tables. |
| virtual subdomain | Subdomain name created by registering its |
| name (VS) | subdomain name's text in a VSserver, and not in its |
| | coupled domain's DNS routing tables. Of course, a |
| | VSAserver, VSAFSserver, and VSFSserver can also |
| | be used instead of a VSserver. |
| VSA | An address comprising of a virtual subdomain name |
| | prefixed in front of a period which is in front of a |
| | registered domain name. A virtual subdomain |
| | address is not registered in and not recognized by |
| | DNS, but is registered and recognized by a |
| | VSserver. |
| VSAFS | A VSA followed immediately by a file suffix. |
| VSserver | Server that receives VSAs or virtual subdomain |
| | names, has these addresses or names registered in its |
| | database, and processes these. VSAserver, unlike |
| | VSserver, frequently examine domain names. |
| VSAserver | Server similar to a VSserver and can service |
| | multiple domains. |
| VSFSserver | Server that is similar to VSserver except that it |
| | further uses the file suffix to process and redirect. |
| VSAFSserver | Server that uses subdomain, domain, and file suffix |
| | to process and redirect. |

Prior Patents Applications & Figures Numbering

Table 1 below shows the prior patent applications submitted by Chen Sun and Azkar Choudhry. These explain how a virtual subdomain address can be created, associated with contacts information, set into an index of such addresses and exchanged as a contacts management system.

TABLE 1
Prior Patent Applications on VSA technologies

| Patent | |
|---|---|
| Application | |
| Number | Patent Title |
| 09/476,632 | System and Method for Dynamic Creation and |
| | Management of Virtual Subdomain Addresses |
| 09/642,127 | System and Method for Interactive Data Services |
| | Using Virtual Subdomain Addresses |
| 60/267,943 | Organizing and Accessing Electronic Business |
| | Cards by Virtual Subdomain |
| 10/074,081 | Contacts Management Using Virtual Subdomains |

### OBJECTS AND ADVANTAGES

Virtual subdomain address (VSA) can be used as part of a Uniform Resource Locator (URL), but previously, VSA could not have the file suffix portion of a URL. This application enables for file suffixes to be added to VSAs-forming a VSAFS.

VSAFS appear identical as a standard URL, but work differently.

The creation of VSA with file suffix (VSAFS) changes the way that the Internet's URL system can work. Using VSAFS and HTTP (hypertext transfer protocol), the vast majority, if not all, the file suffixes and subdomains of a domain can be directed to resources other than its standard subdomain and file suffix resources. A VSAFS appears identical to a standard subdomain-domain-file-suffix address, yet work differently.

An example of these differences is below:

For example, using the URL, http://tm.uspto.gov/gen_info. For a standard-URL to display this URL on a browser, a default file, usually index.html, should be in the gen_info subdirectory, else an error occurs. The same named VSAFS-URL would allow for gen_info to be used without a default file (though admittedly, a VSAFS redirection (explained later), if incorrect, may also cause an error).

VSAFS allow for organization and security (by hiding) of VSA web content

A Virtual subdomain addresses (VSAs) can create web content, just like a standard subdomain address. This is explained in Table 1's patent applications.

Prior to this invention, it was necessary to use hyperlinks and URL addresses to organize VSAs' web content and to use password access to make portions private. However, hyperlinking requires additional mouse clicks and passwords are difficult to recall, and both techniques may require additional steps in sending information.

VSAFSs can organize web content by using the file suffix to separate the VSAs' web content. Furthermore, a VSAFS can provide a moderate degree of privacy and security because if a file suffix is unknown to others, it is safe; for example, if a file suffix “78kcx235/7893k/235” is used, then the sample URL BobSmith.ABC.com/78kcx235/7893k/235 can be used as a barrier to easy web information. Also search engine robots are unlikely to find or index VSAFSs. Table 2 shows some of the advantages of VSAFSs as these are used in organization and security.

TABLE 2
Comparison of VSA Organizing and Security Mechanisms

| | | VSA without file | |
|---|---|---|---|
| | | suffix using | |
| | VSA without file | hyperlinks off of | |
| | suffix using | main virtual | VSAFS--VSA |
| | independent | subdomain | with file |
| | passwords | address webpage | suffix |
| Can achieve a | Yes | No | Yes |
| degree of privacy | | | |
| Able to be | Using standard | Yes | Yes |
| emailed as a | URL, No. | | |
| independent | Passwords are | | |
| entity without | typically sent | | |
| requiring | separately and | | |
| additional typing | require additional | | |
| | typing. Special | | |
| | modifications | | |
| | would have to be | | |
| | made in the | | |
| | browser. | | |
| Storable in | Yes | Yes, but | Yes |
| browser favorites | | hyperlinked | |
| folder and other | | URLs may not | |
| places where | | have subdomain | |
| URLs are stored | | or domain names. | |
| Typing time into | Using standard | Once and then | Once and then |
| browser reduced | URL, No. Each | storable as link. | storable as |
| | time, password | | link. |
| | needs to be | | |
| | retyped. | | |
| Search engine | No | Possible, if right | Unlikely. |
| robot searchable | | robot algorithm is | |
| | | used | |

### BRIEF DESCRIPTION OF THE DRAWINGS

FIG. 1 (Prior Art)—how the standard Internet domains, and subdomains work

FIG. 2 (Prior Art)—a web server

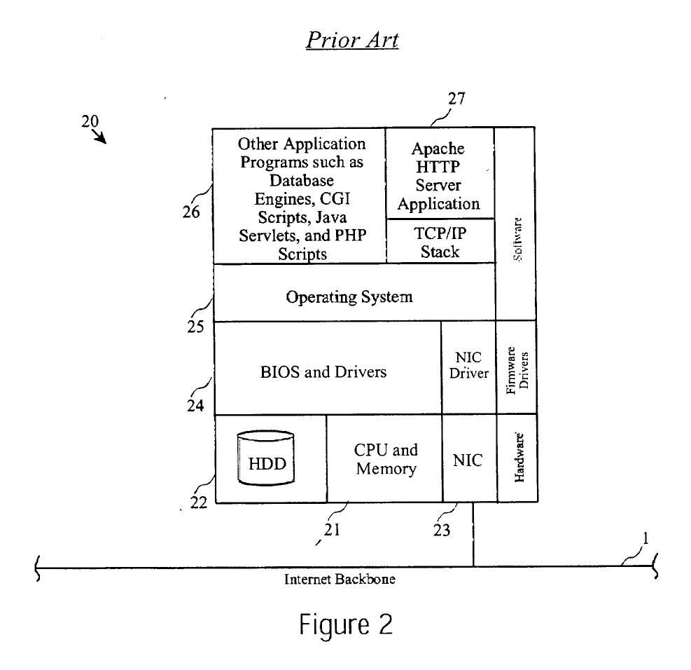

FIG. 3 (Prior Art)—how browsers, DNS, ISPs, and domain servers work

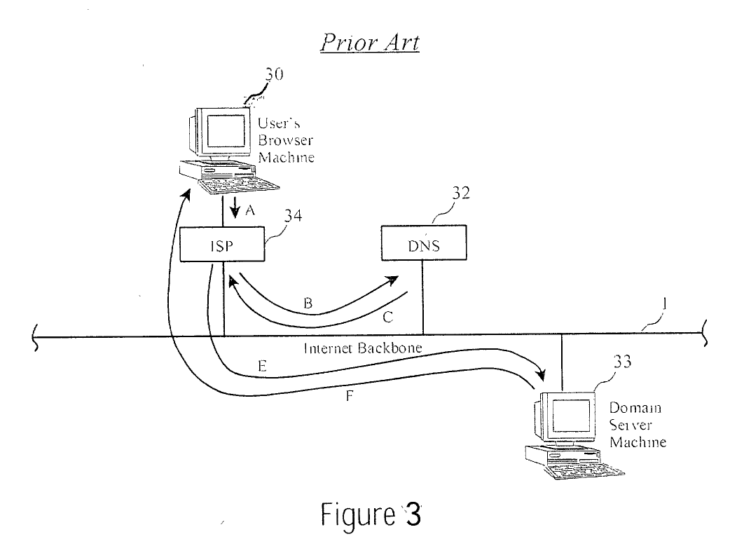

FIG. 4 (Prior Art)—sample of WebBlZcard, a virtual subdomain address web business card

FIG. 5 (Prior Art)—how a Virtual Subdomain Address is created

FIG. 6—Forming VSAFSs using VSFSserver

FIG. 7—Forming VSAFSs using VSAFSserver

FIG. 8—Using a VSAFS

### DETAILED SPECIFICATIONS

A. Virtual subdomain address (VSA) used as a VSA web business card, WebBIZcard (Prior Art)

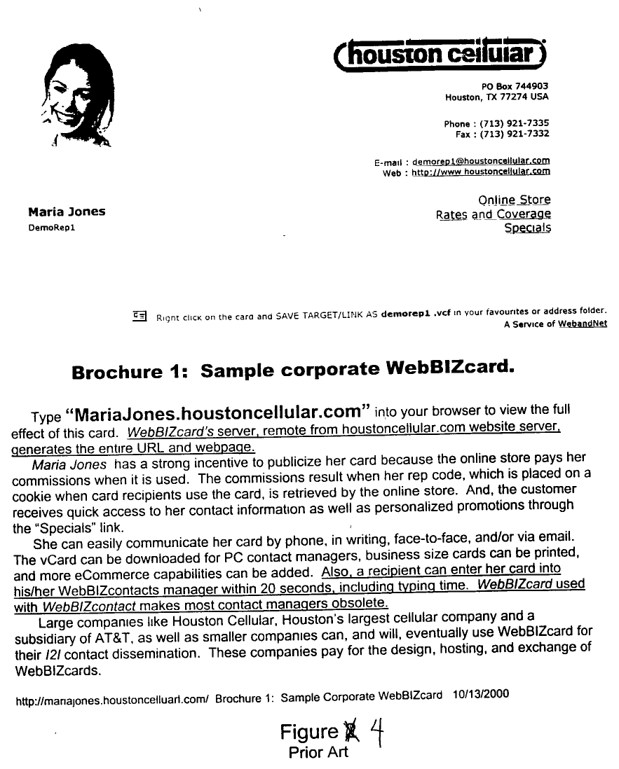

FIG. 4 (Prior Art) is an example of a WebBIZcard (VSA generated webpage) using the domain name HoustonCelluar.com. In response to the VSA request “MariaJones.HoustonCellular.com” the VSserver supplies a web business card, called WebBlZcard. A web business card using VSA can contain more contacts information than as seen in FIG. 4. Such information can be product offerings, personal information, areas of specialization, assistants, team members, and more.

However, the ability to release different levels of information to different people is a desired feature with a VSA web business card. Though a VSA can present all kinds of and abundant information, it would be better, if it's possible, to easily organize and sometimes hide some of this information. Furthermore, as a VSA can be part of URL, it would be better still if the file suffix portion of the URL can be used with VSA. Hence the needs arise for this invention.

B. How Virtual Subdomain Address (VSA) works (Prior Art)

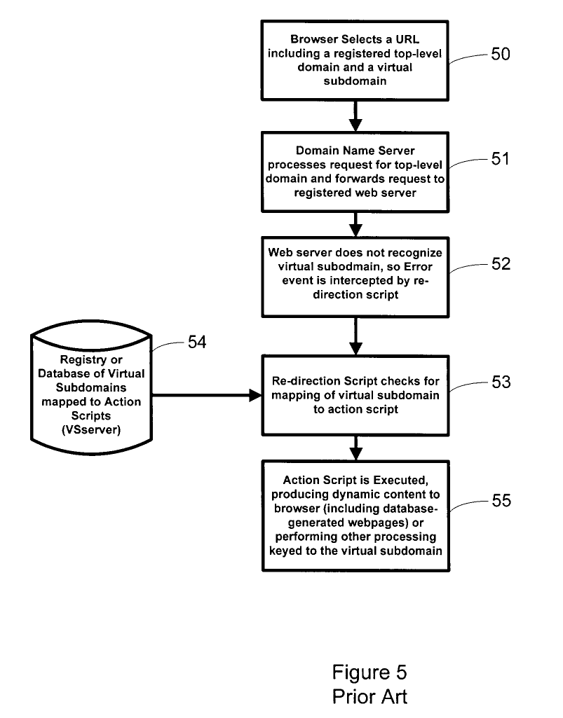

FIG. 5 (Prior Art) shows in an example of a technology used to create a VSA (recall, without the file suffix), as explained in patent applications 09/476,632, 09/642,127, and 60/267,943 of Table 1. When a user submits a URL with a VSA through his browser (50), a Domain Name Server processes the domain and forwards the request to the registered web server (51). Because the standard subdomain doesn't exist, the domain's web server returns an error message (52). The error message is intercepted (52), and then the VSA request is further processed by a VSserver (53 & 55). In this case, the VSserver parses the VSA request, analyzes the subdomain name to process an associated computing script and returns a dynamically-generated webpages to the user's browser (55). Thus, the user's sees the webpages of a VSA.

Another example would be where the web and/or domain name servers does not generate an error message upon receiving a VSA, but instead automatically forwards the not-found-condition of the VSA to a pre-assigned address. This address can hold a VSserver that can return a VSA-specific web page to the initial request.

A third example would be similar to above with a VSAserver that parses the URLs for multiple domain names, instead of one.

C. Prior to this invention, virtual subdomain addresses could not have “file suffixes”

A standard subdomain can have file suffixes. Recall above:

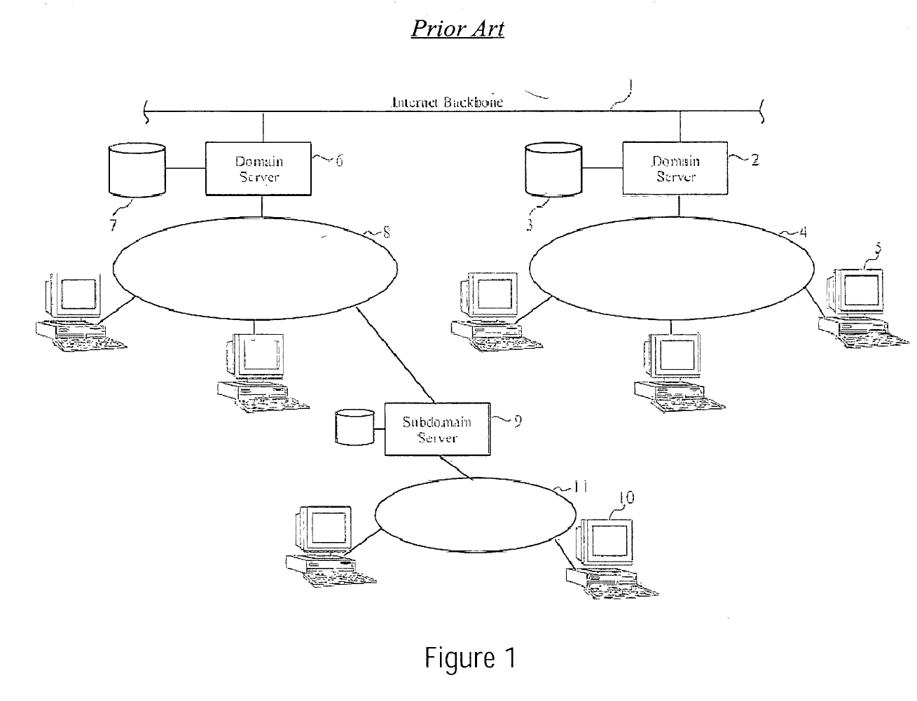

For example, a subdirectory on the US Patent and Trademark Office's web server which contains general information might be named “gen_info”, and could be addressed as “www.uspto.gov/gen_info”. Subnetworks and virtual subnetworks may be addressed by prefixing the general domain name with a subdomain name or names. For example, a subnetwork which serves only the trademark division of the U.S. Patent and Trademark Office may be given the (standard) subdomain name “tm”, allowing the subdomain server (such as 9 in FIG. 1) to be addressed as “tm.uspto.gov”. The two addressing schemes can be combined, such as “tm.uspto.gov/gen_info”, which would access a default file generally index.html, in the gen_info subdirectory located on the tm subdomain server . . .

A virtual subdomain address (VSA) does not have a listing in the DNS table, and calls to it are redirected. VSA had lacked file suffixes because, previously, standard file suffixes referred to directory or files on hosts. A VSA's file suffix had no meaning.

D. Prior to this invention, a URL using VSA with a file suffix was seen as not useful and, if it was possible, as inefficient

A standard subdomain-domain-file-suffix combination (ones that use the standard DNS and the standard subdomain and file suffix addressing methods described in the above background section) can have all the capabilities of a VSAFS and is easier to create. The standard and virtual have identical appearance, and both are used in URLs and DNSs. As it was thought, any file suffix with virtual subdomain addresses (VSAFSs), if these existed, should also be less efficient. A standard subdomain-domain-file-suffix combination doesn't require the additional programming steps and special servers that a VSAFS will be seen to require. There were no obvious need for, no obvious use for, and no invention for VSAFSs.

E. How a file suffix on a virtual subdomain address can be useful and efficient?

Many people did not want a publicly available web business card (A VSA business card—WebBIZcard—FIG. 4), because they wanted to control their privacy. Some mechanisms that could have been used to solve this would have been different levels of passwords, special codes, email response systems, cookies, passwords embedded in URLs, etc. Disadvantages of these mechanisms include: passwords and special codes are difficult to remember, email response systems take up time, and cookies can be lost. Furthermore, some of the above mechanisms can not prevent a search engine from making their web content from being public.

What was needed was an email-able, easy-to-communicate, easy-to-store, easy-to-recall, web business card with privacy and/or security. The criterion “easy to communicate” was particularly important. In order for such a system to be used, it would have to be easily communicated by speech and writing, as well as electronically.

To fully understand this, let's evaluate the vCard by Internet Mail Consortium. This industry-standard contacts management exchange system contains many data fields. It is email-able, software-exchangeable, and it has privacy in that a recipient can only receive it if it is sent. It is well suited for data communications. However, it is not speech or writing communicable. Thus, relative to the size of the Internet audience, it is infrequently used.

The growth of the Internet taught the general population to easily communicate a URL. For example, the URL syntax “http://” “www” “/”, and “.” are easily and commonly communicated by speech and writing. The URL is among the most efficient, potentially short, and well-established ways to humanly communicate and exchange computer-based information, and could serve well in data, speech, and writing communications. It can be used to communicate and exchange a web business card by simply stating a URL address. Due in part to its multi-channel communications capabilities, a URL can help build the mass adoption necessary to make popular a web business card exchange system. Without the mass adoption, any business card contact system will be crippled.

In a URL, typically, the domain name indicates an organization. To communicate information about an individual who is part of an organization, the name can be appended as a subdomain or a file suffix. Most people prefer a subdomain because it is in front of the domain name. Thus, the places to add additional security and exchange information about the individual were either in the suffix or in front of the subdomain. Because people prefer their names first, the file suffix is preferred for security and exchange information.

Hence, a file suffix used with a virtual subdomain address would be useful as a web business card for a number of reasons:

1. email-able,

2. provide certain degree of privacy and security,

3. provide a way to exchange secured information,

4. electronically transferable and manageable by computing equipment,

5. is easy to understand by people,

6. if short, can be easily speech communicated and understood,

7. if short, can be easily written by people,

8. does not interfere with the preferred location of the subdomain that represents the individual and or the domain, his associated organization,

9. already understandable by lots of people as a URL.

Seeing the above advantages, the challenge to creating this invention was to meet the above requirements and further require no adjustments in existing DNS or browser structure. This invention, virtual subdomain address file suffix (VSAFS) achieves all the above criteria.

F. Sample Data to Help Explain the Invention

To explain the invention, we will use the data in Table 3

TABLE 3
Sample Data for Virtual Subdomain Address with File Suffixes

| Virtual Subdomain | | | |
|---|---|---|---|
| Address (VSA)— | | File-suffix-action- | |
| BobSmith.ABC.com | | script-webpage | |
| User entered file suffix | Webpage display | template used | VSAFS |
| products | Webpage with products | Products | BobSmith.ABC.com/products |
| | that BobSmith sells | | |
| secret | Webpage with BobSmith's | Personal | BobSmith.ABC.com/secret |
| | personal information | | |

The invention is realized in its preferred embodiment as follows:

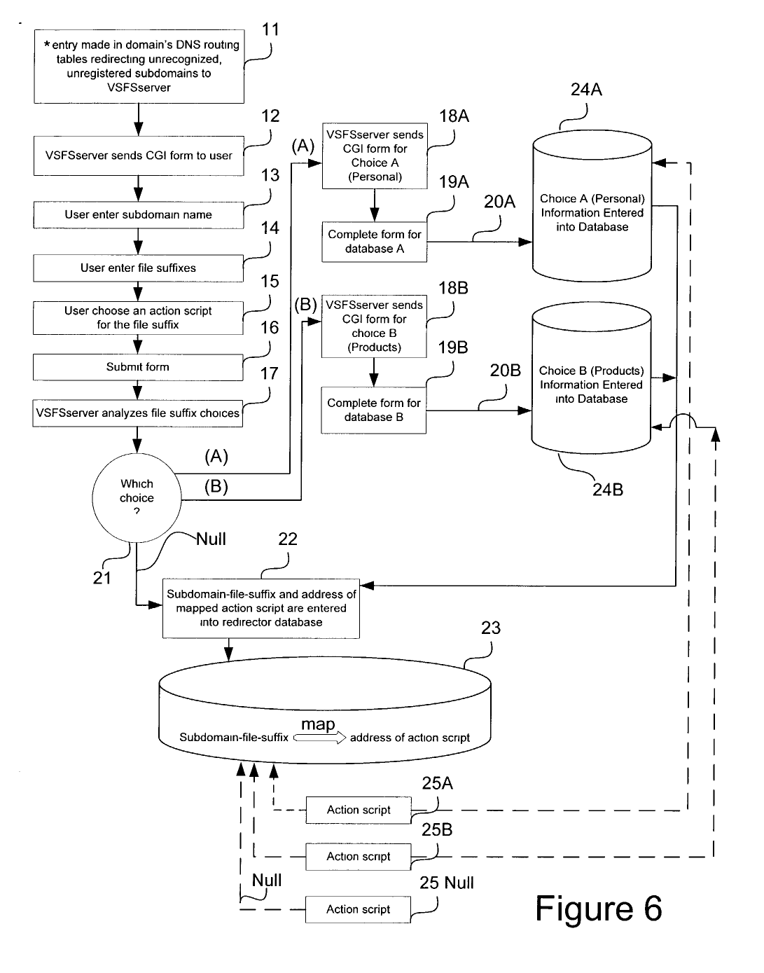

G. FIG. 6_Forming the VSAFS using VSFSserver

In this figure, where there are the letters A or B following the numbers in the labels, these lettering indicate which choice the user made (either A or B) and the A or B programmed path then follows. Where in the below text explanation, only the numbers are used and the associated figure's number has a letter, this text means either A or B is appropriate, depending on the choice made, or sometimes both A & B. This can be determined through the context as A&B are taking parallel actions. There can be more than two choices, and these additional choices are not shown on the figure.

1. As explained in Table 1's patent applications, a “*” entry is made (11) in the DNS Routing Table of domains that will have virtual subdomains. Such * redirects all unregistered/unrecognized subdomain addresses to a designated machine running a VSFSserver. Explaining using Table 3's sample data, a “*” entry and redirected IP numeric address (e.g. 155.1 79.00.213—the web server's address) are placed (11) in ABC.com's DNS routing tables to redirect to the VSFSserver on a web server.

2. The VSFSserver sends (12) to the user's browser a CGI form requesting the user enter (13) his subdomain name. A request for the domain name typically isn't necessary, as a VSFSserver is typically tied to one domain. Where the domain name is unknown, the CGI form may also request a domain name. Explaining using Table 3's sample data, the user receives a data entry request form and enters (13) “BobSmith” for his subdomain, and if needed, “ABC.com”

3. The form further asks the user to enter (14) his file suffix names and his choices (15) of action scripts for these file suffixes. The user can enter in any file suffix name that is acceptable in standard URL file suffix format. Explaining using Table 3's sample data, the user enters (14) “products” and chooses (15) the Products Template action script. Next, the user enters (14) “secret” and chooses (15) the Personal Template action script.

4. The user submits (16) this CGI form.

5. The VSFSserver receives these, examines (17), and initiates the action scripts for the respective choices (21). Typically, the choices' action scripts involve populating information on various database driven webpage designs. A second set of CGI forms, requesting for web database information that correspond to the file suffix action script choices, may be sent (18) to the browser. Explaining using Table 3's sample data, “Products” and “Personal” database-information-request-action-scripts are launched based on the user's choices. These send back (18) to the user the Products CGI form containing data entry fields for the user's products offerings and the Personal CGI form containing data entry fields for the user's personal information. These CGI forms can, of course, upload graphics and photographs.

6. The database information request forms are completed and submitted, and the VSFSserver stores (20) these entered data into respective databases (24). Explaining using Table 3's sample data, the Personal form data is stored into Personal database (24a) and likewise for Products form data is stored into the Products database (24b).

7. For each file suffix, the VSFSserver now adds the subdomain name and maps (22) this combination to an address. The subdomain name, file suffix, and mapped address are then stored as a record in a redirector database (23). Explaining using Table 3's sample data, BobSmith, products, and its address to initiate Bob's products webpages are stored as a database record. Similarly, BobSmith, secret, and its address to initiate Bob's personal webpages are also stored as a database record.

8. The mapped address will initiate (25) an action script that creates web objects based on the user's choice of action script for the subdomain-file-suffix combination and the subdomain and file suffix names. Typically, these web objects are webpages generated from database information previously submitted for the virtual subdomain-file suffix combination. These web objects are then sent in response to the browser's URL requests containing the virtual subdomain-domain-file-suffix combination. Explaining using Table 3's sample data, if BobSmith.ABC.com/products were entered into a user's browser's URL box, the VSFSserver would redirect this URL to cause an action script (25B) that would query the Products database (24B) for BobSmith's entered products data and respond to the initiating browser with BobSmith's products webpages.

9. In the condition where no file suffix was entered in step 3 (for example, null suffix is a choice (21 null)), a virtual subdomain mapping with null suffix to an address with an action script still occurs (22). This action script (25 null) frequently generates a webpage based on the subdomain name. Suppose BobSmith and null file suffix were entered as a choice, when BobSmith.ABC.com is requested, a redirection would occur to an action script, and typically a BobSmith.ABC.com webpage with his generic contacts information would be sent back. FIG. 4 shows how a response might display with MariaJones.HoustonCellular.com.

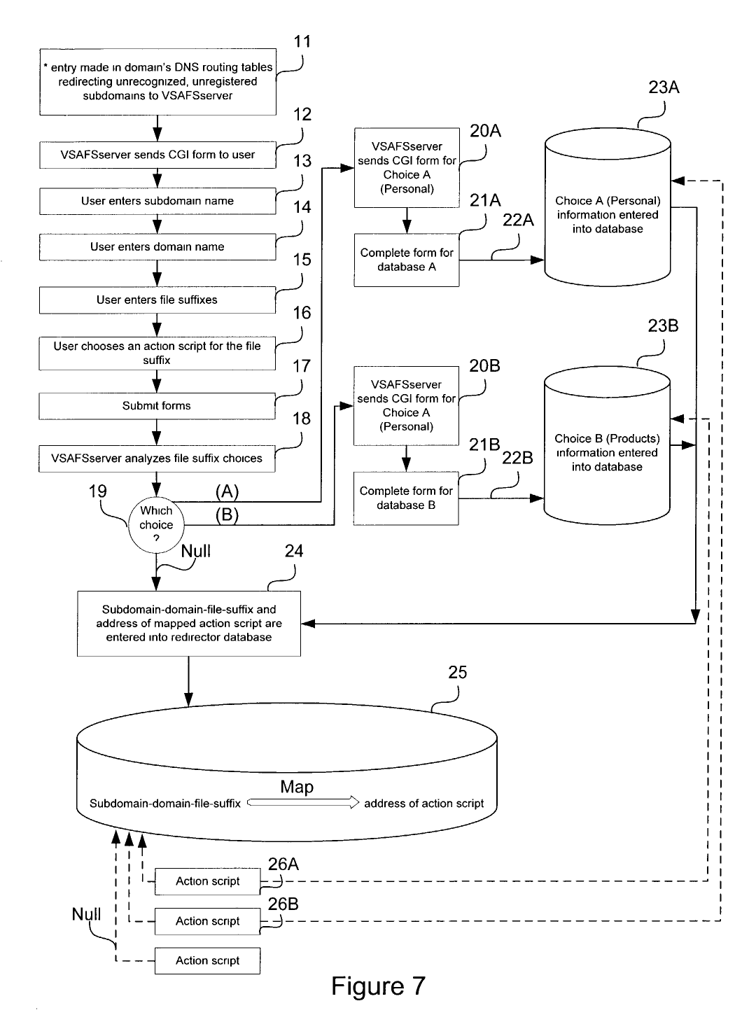

H. FIG. 7—Forming the virtual subdomain address file suffixes using VSAFSserver

The process for a VSAFSserver is similar to that of a VSFSserver except that a domain name frequently has to be specified and that a domain name is a required field in the redirector database. The advantage of a VSAFSserver is that it can efficiently handle multiple domains. Below is a similar explanation.

In this figure, where there are the letters A or B following the numbers in the labels, these lettering indicate which choice the user made (either A or B) and the A or B programmed path then follows. Where in the below text explanation, only the numbers are used and the associated figure's number has a letter, this text means either A or B is appropriate, depending on the choice made, or sometimes both A & B. This can be determined through the context as A&B are taking parallel actions. There can be more than two choices, and these additional choices are not shown on the figure.

1. As explained in Table 1's patent applications, a “*” entry is made (11) in the DNS Routing Table of domains that will have virtual subdomains. Such * redirects all unregistered/unrecognized subdomain address to a designated machine running with a VSAFSserver. Explaining using Table 3's sample data, a “*” entry and redirected IP numeric address (e.g. 155.1 79.00.213—the web server's address) are placed (11) in ABC.com's DNS routing tables to redirect to the VSAFSserver on the web server.

2. The VSAFSserver sends (12) to the user's browser a CGI form requesting the user enter (13) his subdomain name. Depending on the business and website arrangements between the domains and the VSAFSserver, a request for the domain name may be unnecessary, as a VSAFSserver can frequently determine the domain name from the mechanism of the * forwarding and received packets. Where the domain name is unknown or uncertain or the business arrangements between VSAFSserver and the domains serviced do not allow, the CGI form will also request a domain name (14). Explaining using Table 3's sample data, the user receives a data entry request form and enters (13) “BobSmith” for his subdomain, and if needed, “ABC.com” (14).

3. The form further asks the user to enter (15) his file suffix names and his choices (16) of action scripts for these file suffixes. The user can enter in any file suffix name that is acceptable in standard URL file suffix format. Explaining using Table 3's sample data, the user enters (15) “products” and chooses (16) the Products Template action script. Next, the user enters (15) “secret” and chooses (16) the Personal Template action script.

4. The user submits (17) this CGI form.

5. The VSAFSserver receives these, examines (18), and initiates the action scripts for the respective choices (19). Typically, the choices' action scripts involve populating information on various database driven webpage designs. A second set of CGI forms requesting for web database information that correspond to the file suffix action script choices, may be sent (20) to the browser. Explaining using Table 3's sample data, “Products” and “Personal” database-information-request-action-scripts are launched based on the user's choices. These send back (20) to the user the Products CGI form containing data entry fields for the user's products offerings and the personal CGI form containing data entry fields for the user's personal information. These CGI forms can, of course, upload graphics and photographs.

6. The database information request forms are completed and submitted, and the VSAFSserver stores (22) these entered data into respective databases (23). Explaining using Table 3's sample data, the Personal form data is stored into Personal database (23a) and likewise for Products form data is stored into the Products database (23b).

7. For each file suffix, the VSAFSserver now adds the subdomain and domain names and maps (24) this subdomain-domain-file-suffix combination to an address. The subdomain name, domain name, file suffix, and mapped address are then stored as a record in a redirector database (25). Explaining using Table 3's sample data, BobSmith, ABC.com, products, and its address to initiate Bob's products webpage are stored as a database record. Similarly, BobSmith, ABC.com, secret, and its address to initiate Bob's personal webpage are also stored as a database record.

8. The mapped address will initiate (26) an action script that creates web objects based on the user's choice of action script for the subdomain-domain-file-suffix combination and the subdomain, domain, and file suffix names. Typically, these web objects are webpages generated from database information previously submitted for the virtual subdomain-domain-file-suffix combination. These web objects are then sent in response to the browser's URL calls containing the subdomain-domain-file-suffix combination. Explaining using Table 3's sample data, if BobSmith.ABC.com/products is entered into the user's browser's URL box, the VSAFSserver would redirect this URL to cause an action script(26A) that would query the Products database (23B) for BobSmith.ABC.com's entered products data and respond to the initiating browser with BobSmith.ABC.com's products webpages.

9. In the condition where no file suffix was entered in step 3 (for example, null suffix is a choice (19 null)), a virtual subdomain mapping to an address with an action script still occurs. This action script (26 null) frequently generates a webpage based on the subdomain name. Suppose BobSmith.ABC.com and null file suffix were entered as a choice, when BobSmith.ABC.com is requested, a redirection would occur to an action script, and typically a BobSmith.ABC.com webpage with his generic contacts information would be sent back. FIG. 4 shows how a response might display with MariaJones.HoustonCellular.com.

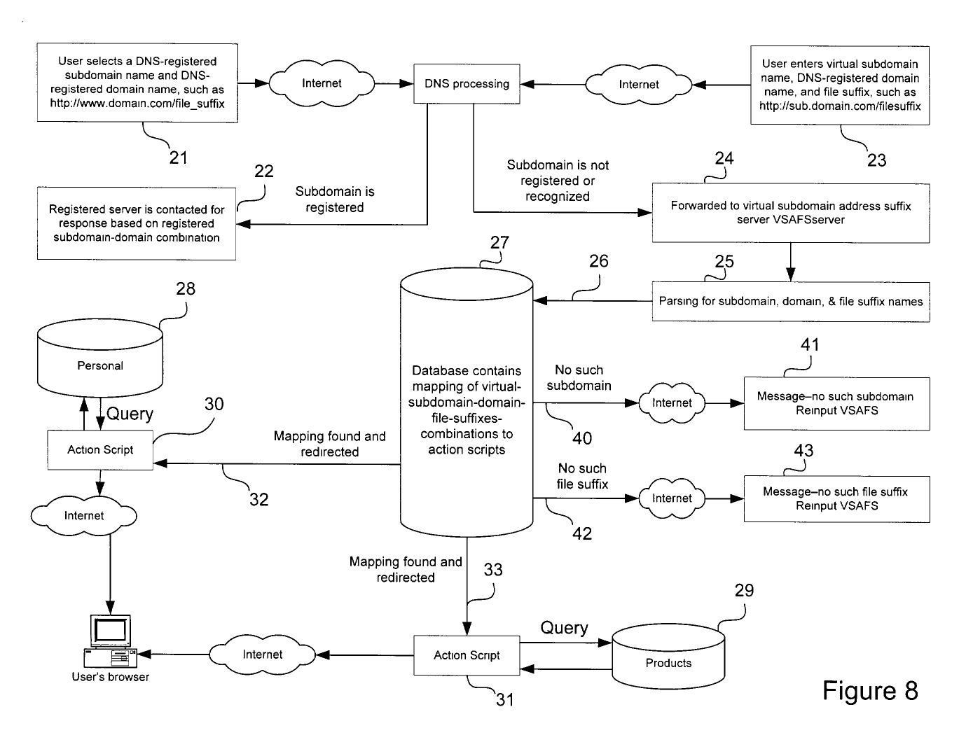

I. FIG. 8—Using a VSAFS

FIG. 8 describes the events when a browser requests a VSAFS. Here a URL containing a subdomain, domain, and file suffix is requested. If the URL entered uses a DNS registered domain name and DNS registered subdomain name (21), then the DNS processes the domain and subdomain to the address assigned to the registered subdomain (22).

However, if the subdomain name is unregistered and unrecognized (23), then it is forwarded by the * entry in the DNS routing table to the VSAFSserver (24). The VSAFSserver and its web server parse and analyze (25) the incoming data for subdomain, domain, and file suffix, and then query (26) the redirector database (27) containing mapping of VSAFSs and redirection addresses. If mapping is found (32 or 33), the request is redirected, and an action script (30 or 31) then takes place. Typically a responding webpage is sent with database information associated with the virtual subdomain-domain-file-suffix combination. The common “404” (file not found) errors are avoided.

Explaining using Table 3 sample data, if the browser requests BobSmith.ComA.com/Personal, the VSAFSserver would extract BobSmith's personal information from the Personal database (28 in FIG. 8-23A in FIG. 7) and in conjunction with the web server, respond with a webpage containing BobSmith's personal information. Likewise, if the browser requests BobSmith.ComA.com/Products, the VSAFSserver would extract BobSmith's products information from the Products database (29 in FIG. 8-23B in FIG. 7) and in conjunction with the web server, respond with a webpage containing BobSmith's products information,

There are situations where some of the subdomains or file suffixes do not exist in the redirector database. The following actions are preferred. If no virtual subdomain name is found (40), an error message will be generated, explaining no such subdomain and asking the user to re-input the VSAFS. If the subdomain name is found, and a file suffix was included in the request, but no file suffix is found (42) in the redirector database, an error message will be generated, explaining no such file suffix and asking the user to re-input the VSAFS (43). If the subdomain is found, and there was no file suffix included in the request, then the action script is mapped to no file suffix condition.

If a VSFSserver is used instead, the process is similar, except that the domain name may not be in the redirector database and the VSFSserver typically serves only one domain.

There are, of course, numerous other ways to generate this invention. One could be that the user may have been already assigned a subdomain name and requested to provide only the file suffix names. Another is that instead of choosing the pre-programmed action scripts to associate with a file suffix name, the user is simply provided with a preferred routing IP or URL address entry box and the entered information is used to redirect. Thirdly, obviously, there can be more than the two file suffix action scripts and databases, in the examples above. Fourth, instead of having user-entered file suffix names, the names for the file suffixes may be pre-assigned. Fifth the database providing file suffix information, e.g. the Products and Personal databases, may be populated independently of the CGI-forms-entry method described above. It can, for example, be extracted from a corporate database, edited after initial entry and populated independently of the file suffix redirection creation process above. Sixth, instead mapping to an address to initiate an action script, the redirector mapping could initiate the action script. Seventh, instead of having choices of action scripts, there may be just one action script, and the user not have a choice.

While the disclosure contained herein has set forth a preferred embodiment of the invention, and many of the fundamental components used within the invention are well known within the art, it will be appreciated by those who are skilled in the art that variations to the combination of elements and steps disclosed can be made without departing from the scope and spirit of the invention. Such variations may include, but are not limited to, selection of alternate web server hardware platforms, operating systems, and HTTP server suites, as well as implementation of the process as a servlet or other program embodiment.

What is claimed is:

1. A method for redirecting an Internet subdomain address with a file suffix to a virtual subdomain with file suffix on an Internet domain name serer, comprising the steps of:
a. receiving from an Internet worked client computer a request for an Internet document at an unrecognized unregistered subdomain address with an unknown file suffix;
b. executing a redirection script on said domain name server in response to said request for said unrecognized unregistered subdomain address with an unknown file suffix;
c. accessing a computer-readable record by said script to determine a subdirectory or recognized and registered domain name assigned to said unrecognized unregistered subdomain and file suffix
d. redirecting said request to said subdirectory or recognized and registered domain name such that said request results in a request to a recognized domain name or to a subdirectory of a recognized domain name on a web server, thereby allowing the request to be fulfilled by said web server which hosts the recognized domain name or subdirectory of the recognized subdomain name.

2. A method for redirecting an unregistered and unrecognized Internet subdomain address with a file suffix to a virtual subdomain with file suffix on an Internet domain name server, comprising the steps of:
a. The user selecting a name of the said file suffix,
b. The VSAFS formed leads to a webpage,
Such that the user can use the name of the file suffix as a security mechanism for the information displayed.

3. A method whereby the redirector database for VSAFS are formed comprising of
a. User selecting a unregistered unrecognized subdomain name as a virtual subdomain name,
b. User selects a file suffix name and associates this with a template driven database record.
c. Combining the virtual subdomain name, file suffix name, and domain name into a database that, when accessed for the VSAFS record, returns an address that the generates the page of the template driven database record
d. Such that the end result is that the VSAFS shows a webpage.
Additional claims will be added, as I had been informed by the patent office assistance that claims can be revised and added.
